(19) United States
(12) Patent Application Publication
(10) Pub. No.: US 2003/0029969 A1
(43) Pub. Date: Feb. 13, 2003

(54) System and method for orbiting spacecraft servicing

(76) Inventor: Andrew E. Turner, Mountain View, CA (US)

Correspondence Address: Perman & Green, LLP, 425 Post Road, Fairfield, CT, 06430, US

(21) Appl. No.: 10/201,243

(22) Filed: Jul. 23, 2002

Related U.S. Application Data
(60) Provisional application No. 60/307,564, filed on Jul. 23, 2001.
(60) Provisional application No. 60/308,181, filed on Jul. 27, 2001.

(51) Int. Cl. B64G 1/22; B64G 1/00

(52) U.S. Cl. 244/158 R

(57) ABSTRACT

An orbiting spacecraft payload delivery system for delivering a payload to an orbiting spacecraft, the system comprising a launch vehicle, a mobile launcher, and an orbiting reusable space tug. The launch vehicle as a payload module for holding of the payload for the orbiting spacecraft. The mobile launcher is adapted to transport the launch vehicle. The orbiting reusable space tug ferries the payload module to the orbiting spacecraft. The mobile launcher transports the launch vehicle to a predetermined location disposed within a distance from a ground track of the orbiting spacecraft for launching the launch vehicle from the predetermined location.

### CROSS-REFERENCE TO RELATED APPLICATION(S)

This application claims the benefit of U.S. Provisional Applications No. 60/307,564, filed Jul. 23, 2001, and No. 60/308,181, filed Jul. 27, 2001 which are incorporated by reference herein in their entirety.

### BACKGROUND OF THE INVENTION

1. Field of the Invention

The present invention relates to in orbit spacecraft servicing systems and methods, and more particularly, to re-supplying an orbiting spacecraft using a low cost space tug.

2. Brief Description of Earlier Developments

There is an ever increasing interest in the commercial exploitation of space. Part of this interest is directed at an area which is believed to be more exploitable in the near future by placing orbital platforms/spacecraft to conduct any number of commercial and scientific space activity. These activities may include for example scientific observation, space tourism, to any number of micro-gravity industrial application including material manufacturing/processing, pharmaceutical and bio-chemical processing to mention just a few. The orbital platforms may be manned or unmanned, and may be pressurized or unpressurized. Some of these aspirations have been realized in a very limited fashion, and with very limited commercial success with earlier orbital “space stations” such as Skylab, the Soviet space stations including Mir, and today with the International Space Station (ISS) which has become operational. It can be envisioned that many more orbital platforms will exist in the future, although their number will depend on how economically they will be operated. As it is on Earth, the success of any commercial space venture will be its ability to produce a profit, and hence, the operating costs must be considered. Even in the case of non-profit or scientific ventures operating costs are a main concern. As can be immediately recognized, a very significant part of the operating costs of any space based venture is the cost of boosting consumables, repair parts, spaces and other operating items used in the operation of the venture to the orbital platform. The current approach is illustrated by the manner in which the ISS is resupplied. Consumables and other resupply items for the ISS are placed as stowed payload on a reusable launch vehicle (i.e. the manned space shuttle). Otherwise, the resupply payload may also be placed in the payload module on the upper stage of an expendable launch vehicle (such as for example the Russian Progress/Proton expendable launch vehicle). In both cases, the launch vehicles are launched from fixed launch sites, such as the Kennedy Space Center during a suitable “window” when the ISS is located with respect to the launch site to ensure that the launcher delivers the payload to the ISS. In the case of the reusable launch vehicle, the launch vehicle itself docks with the ISS to deliver the payload. In the case of the expendable launch vehicle, the upper stage delivers the payload module to the ISS. Neither of these launch means have proven adequate to provide launch costs of resupply items which are satisfactory.

Moreover, launching from a fixed launch site, as is presently the case, generally results in substantial waiting periods in orbit to achieve phasing for rendezvous opportunities, or requires inefficient dog-leg maneuvers to alter the orbit plane during the ascent phase. This has an adverse effect especially on delivery of priority payload to the orbital platform. The present invention overcomes the problems of the conventional resupply methods by employing are supply system having a mobile launcher and a low cost space tug or reusable transfer vehicle. The mobile launcher uses an air- or sea-launch capability that is highly advantageous for rapid call-up launch, where payload delivery would occur as soon as possible after cargo liftoff. The total time from receiving a call for launch and on-orbit delivery would be one week or less. This is not possible using the conventional launch systems. The space tug allows for maximization of the cargo mass fraction of the launch vehicle final stage, as will be described further below, which makes most efficient use of mass ferried through maneuvers to the orbital platform.

Conventional launch system, as described previously, suffer a further handicap which results in reduced cargo mass fraction for the launch vehicle final stage because of the configuration of the payload module of the launch vehicle final stage. As noted before, the payload module of the final stage in the conventional launch systems is docked to the ISS to effect resupply. Accordingly, the construction/structure of the payload module is “heavy” to provide a pressurized volume and withstand the large stresses associated therewith. The pressurized volume in the payload module is needed to allow the module to be directly interfaced to the pressurized docking port of the ISS. Payload mass thus may be in the order of about 15% of the total payload module mass in conventional launch systems. The system of he present invention uses a payload module that is not pressurized. An unpressurized payload docking adapter interfaces with the payload module, allowing the unpressurized payload module to be docked to the pressurized docking port of the orbital platform. As can be realized, by using an unpressurized payload module the cargo mass fraction of the payload module may be increased significantly with corresponding benefits to the payload launch costs. The system of the present invention overcomes the problems of the prior art as will be described in greater detail below.

### SUMMARY OF THE INVENTION

In accordance with a first embodiment of the present invention, an orbiting spacecraft payload delivery system for delivering a payload to an orbiting spacecraft is provided. The system comprises a launch vehicle, a mobile launcher, and an orbiting reusable space tug. The launch vehicle has a payload module for holding a payload for the orbiting spacecraft. The mobile launcher is adapted to transport the launch vehicle. The orbiting reusable space tug ferries the payload module to the orbiting spacecraft. The mobile launcher transports the launch vehicle to a predetermined location disposed within a predetermined distance from a ground track of the orbiting spacecraft for launching the launch vehicle from the predetermined location.

In accordance with another embodiment of the present invention, an orbiting spacecraft payload delivery system for delivering a payload to an orbiting spacecraft in a predetermined orbit plane is provided. The payload delivery system comprises a launch vehicle, a mobile launcher, and a reusable orbiting tug. The launch vehicle has a payload module for holding the payload for the orbiting spacecraft. The mobile launcher is adapted to transport the launch vehicle. The reusable orbiting tug ferries the payload module to the orbiting spacecraft after the payload module is released from the launch vehicle. The mobile launcher transports the launch vehicle to a predetermined location for launching the launch vehicle from the predetermined location. The predetermined location is in the orbit plane of the orbiting spacecraft.

### BRIEF DESCRIPTION OF THE DRAWINGS

The foregoing aspects and other features of the present invention are explained in the following description, taken in connection with the accompanying drawings, wherein:

FIG. 1 is a schematic diagram of an in orbit spacecraft resupply system incorporating features of the present invention and an orbiting spacecraft 100;

FIG. 2 is a 2-D graphical representation of the ground tracks of the orbiting spacecraft 100 in FIG. 1;

FIG. 3 is a schematic top view illustrating a portion of the trajectory path of a launch vehicle of the system in FIG. 1 when launched to deliver a payload to the orbiting spacecraft;

FIG. 4 is a schematic side view illustrating the orbit paths of the launch vehicle (LV), and space tug of the system in FIG. 1, to resupply the orbiting spacecraft in accordance with a first method of the present invention;

FIGS. 5 and 5A are respectively a schematic perspective view, and a schematic elevation view of a launch vehicle final stage (LVFS) of the system in FIG. 1;

FIG. 6 is a perspective view of the reusable space tug of the system in FIG. 1;

FIGS. 7A and 7B are respectively perspective views in opposite orientations of the LVFS and space tug stack, and a payload docking adapter of the system in FIG. 1;

FIG. 8 is a schematic diagram depicting a rendezvous portion of the orbit path of the LVFS/space tug stack with the orbiting spacecraft;

FIG. 9 is a is a schematic side view illustrating the orbit paths of the LV, and space tug of the resupply system to resupply the orbiting spacecraft in accordance with a second method of the present invention;

FIGS. 9A, and 9B are graphs respectively illustrating the difference in right ascension of the ascending node (RAAN) of the orbits of the space tug and orbiting spacecraft, and the difference in the argument of latitude (ARGLAT) between tug and orbiting spacecraft when operated according to the second method; and

FIG. 10 is a schematic elevation view of a LVFS in accordance with the prior art.

### DETAILED DESCRIPTION OF THE PREFERRED EMBODIMENT

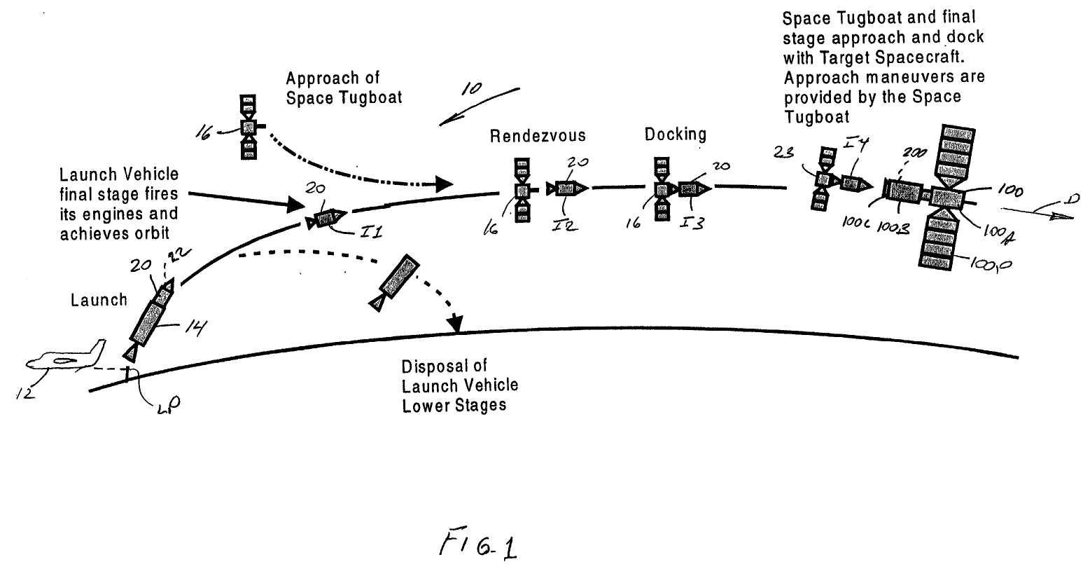

Referring to FIG. 1, there is shown a schematic profile view of a system 10 incorporating features of the present invention for resupplying an orbiting spacecraft 100. Although the present invention will be described with reference to the single embodiment shown in the drawings, it should be understood that the present invention can be embodied in many alternate forms of embodiments. In addition, any suitable size, shape or type of elements or materials could be used.

Referring still to FIG. 1, the orbiting spacecraft 100 is depicted as a representative spacecraft in earth orbit, though the present invention is equally applicable with any suitable type of spacecraft. The spacecraft 100 generally has a bus or service module 100A and a command or payload module 100B connected to the service module. The service module 100A generally may include a power system 100P for generating and supplying power to the spacecraft, attitude control system (not shown) with transfers and/or momentum wheels for attitude control as well as for station keeping, and any other suitable support systems for operating the spacecraft and command module. The spacecraft 100 may be a manned spacecraft that may be continuously and permanently manned such as for example the international space station (ISS), or manned only periodically. In this case, the command/service module may includes a habitation areas for the crew as well as suitable support systems for operating the habitation area. The spacecraft 100 may also be an unmanned platform with no capability for on board personnel when in orbit. In this case however, the command module of the spacecraft may include any desired automated systems for performing any desired processing. For example, the command module may include a fully automated system for material processing (e.g. forming complex chemical compounds, forming material alloys) in microgravity. In any event, it is desired that the spacecraft 100 be periodically resupplied in orbit. Accordingly, the command module, and/or the service module, has a docking port (shown schematically at 100C in FIG. 1) through which resupply payload (e.g. consumables for the crew or for the automated manufacturing process) may be brought into the spacecraft. The resupply payload is launched to the spacecraft 100 with the system 10 shown in FIG. 1 as will be described further below. The system 10 and its operation will be described in the case of the spacecraft 100 being in LED in general with an orbit having the parameters of the ISS orbit in particular, for example purposes only. The present invention is equally applicable to the case of spacecraft in any LEO orbit or in MEO or GEO orbits. The spacecraft 100 in this exemplary case has a circular orbit, represented at O in FIG. 4, with an altitude of about 450KM and an inclination of about 51.6° (which is very close to the maximum altitude of the ISS).

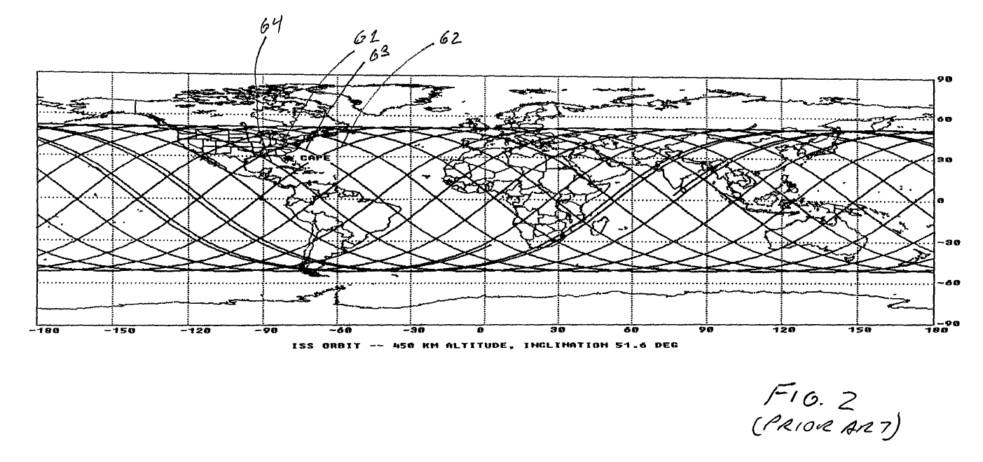

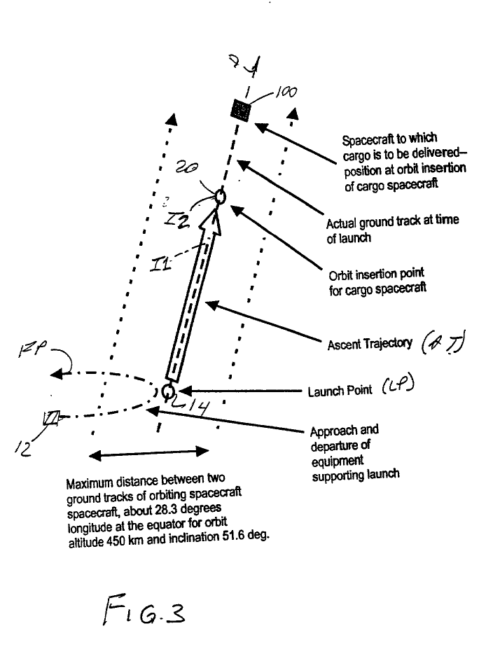

As seen in FIG. 2, the in-orbit spacecraft resupply system 10 generally comprises a launcher 12, a launch vehicle 14, and a reusable space tug 56. The launcher 12, which is a mobile launcher in this case, holds and deploys the launch vehicle 14 for launch as will be described below. The launch vehicle 14, has a final stage (LVFS) 20 with a payload module 22 holding a payload destined for the orbiting spacecraft 100. The launch vehicle 14 boosts the LVFS 20 into orbit. FIG. 1 shows the LVFS 20 in a number of positions I1-I4 along its path to rendezvous with the target spacecraft 100. The reusable space tug 16 is in orbit. The space tug 16 is a low cost spacecraft with appropriate guidance and control capability to rendezvous and capture of the LVFS 20 and to captive-carry The LVFS to the spacecraft 100 to deliver the payload. The space tug 16 is a spacecraft which may not have a refueling capability. The system 10 may also include a payload docking adapter 200 for interfacing the payload module of the LVFS to the spacecraft 100. The adapter is disposed in orbit, and if desired may be carried by the spacecraft 100.

Referring now to FIG. 2, there is shown a 2-D graphical representation of the ground track of spacecraft 100 in orbit O over a representative period of time (such as for example 26 hours). FIG. 2 also shows a representative fixed ground launch site CAPE which may be used by conventional launch systems. As can be seen in FIG. 2, in the time span represented therein, the fixed site CAPE is not traversed by the ground track of spacecraft. Moreover, it is expected that the ground track would not traverse site CAPE for a period of days. Accordingly, as was noted before, any launch from fixed site CAPE during the period represented in FIG. 2, to resupply a spacecraft in orbit O with a conventional launch system, would employ a significant plane change during ascent, or a phasing delay of a few days in orbit, or both. This would adversely impact a “rapid call-up” missing to bring priority or “just in time” resupplies to the spacecraft. The launch and delivery system 10 of the present invention overcomes this problem.

In greater detail now, and with reference again to FIG. 1, the mobile launcher 12 is shown for example purposes only as being in general an airborne launcher and in particular as being an airplane, though any suitable type of aircraft may be used including a lighter than air vehicle. In alternate embodiments, the mobile launcher may be sea borne or water borne based (e.g. ship, towed platform, submersible) or may be ground borne (e.g. ground transporter/launcher). An airborne mobile launcher 12 provides the greatest range over a short time period, and flexibility to reach a desired location traversed by the ground track of the spacecraft 100 in orbit O. The mobile launcher 12 may be such as provided for example by Coleman Aerospace. The Mobile Launcher 12 may include a suitable cargo/transport aircraft carrier and a stowage/deployment system for the launch vehicle. The stowage/deployment system is used to stow the launch vehicle aboard the aircraft carrier and to deploy the launch vehicle rapidly from the aircraft carrier during flight. After separation from the carrier, the deployment system stabilizes the launch vehicle and releases the launch vehicle when still airborne for launch. The aircraft carrier and deployment system of the mobile launcher 12 cooperate to deliver the launch vehicle 20 for launch from an altitude of 15,000 to 20,000 feet. In alternate embodiments, the mobile launcher may deliver the launch vehicle for launch from any desired altitude.

Referring still to FIG. 2, the launch vehicle 14 is depicted as a representative expendable launch vehicle which includes a number of stages as desired, and at least a final stage (LVFS) 20 that has the payload module 22. In the case of the airborne mobile launcher 12 shown in FIG. 1, the launch vehicle 14 is sized to be carried inside or outside of the airborne carrier. In alternate embodiments, the launch vehicle may have any other desired size suited for transport and launch from a desired mobile launcher. In the case shown in FIG. 1, a suitable launch vehicle may be the small Expendable Launch Vehicle concept from Coleman Aerospace. In alternate embodiments, the launch vehicle may be a reusable launch vehicle with one or more reusable stages. The launch vehicle 14, may be for example, a solid booster launch vehicle. The main space of the launch vehicle may include suitable positioning and guidance systems (GPS/INS) to enable the launch vehicle 14 to attain the appropriate altitude when released from the deployment system of the mobile launcher to launch into orbit O of the orbiting spacecraft 100 as will be described further below.

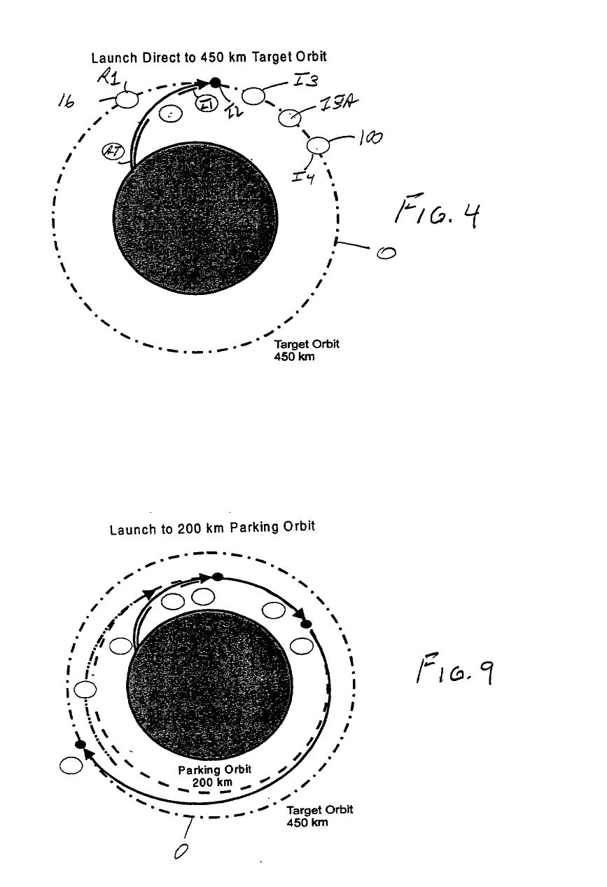

Referring now to FIGS. 5-5A, there is shown a perspective view and a schematic elevation view of the launch vehicle final stage (LVFS) 20. The LVFS 20 is depicted as a representative final stage of the launch vehicle, and in alternate embodiments, the final stage may have any suitable configuration. As seen in FIGS. 5-5A, the LVFS 20 generally comprises a service module 32 and payload module 22 (indicated in phantom). The service module 32 includes structures and system for coupling the LVFS to the launch vehicle during launch. The LVFS 20 also has a thruster 32T for injecting the LVFS into orbit (indicated by position Z1 in FIG. 1). In this embodiment, the LVFS thruster or maneuvering system may be provided with minimal propellant for on-orbit maneuvering. Thus, the LVFS 20 generally has no significant on-orbit maneuvering capability and remains substantially passive once injected into orbit (position Z1). As can be realized, this allows the LVFS to carry a larger payload mass. The service module 32 may have a deck 32D for supporting the payload in the payload module. As seen best in FIG. 5, the LVFS 20 may have an intermediate section 32I disposed between the payload module 22 and service module 32. The intermediate section 32I may have a general disk shape with surfaces 32S configured to form an airtight seal when coupled wit the adapter 200 at the orbiting spacecraft 100 as will be described further below. As seen in FIGS. 5-5A, the payload module 22 is not a module in the conventional sense. Rather, the payload module 22 generally comprises a skeletal support structure 30, depicted in a representative manner in FIGS. 5-5A, and cargo canisters 36. The representation of both the support structure 30 and cargo canisters 36 in FIGS. 5-5A are merely exemplary in nature, and in alternate embodiments the support structure and cargo canisters of the LVFS may have any suitable configuration and size. The support structure 30 depends from the support deck 320 of the service module 32 and has mounting supports 30M for holding the cargo canisters 36. The support structure 30 may have longitudinal support posts, columns or trusses 30P (only one representative post 30P is shown in FIGS. 5-5A for example purposes) to connect the mounting supports 30M to the service module 32. The mounting supports 30M extending from the support posts 30P are shown as being attached to the cargo canisters 36 from an exemplary location (at the top of the canister) though in alternate embodiments, the canisters may be held from any number of suitable locations using any suitable holding means such as clamping, and mechanical fastening with threaded fasteners. As can realized, the cargo canisters 36 are sized in length and width to be admitted through the resupply port of the orbiting spacecraft 100 (see FIG. 1). The ends of the canisters may be removable to provide access to the interior of the canisters, otherwise the canisters may be provided with access panels. The structure of the cargo canisters is capable of maintaining a pressurized interior, and the removable ends or access panels form an airtight seal when closed. The cargo canisters 36 are shown as having a generally cylindrical shape with hemispherical heads at opposite ends for example purposes only, and in alternate embodiments the cargo canisters may have any suitable shape. The cargo canisters 36 in the payload module 22 are also shown as being substantially the same, for example purposes, and in alternate embodiments, the payload module 22 may have different sizes of canisters to suit the payload demands. The support structure 30 may hold any desirable number of canisters (four canisters are shown in FIGS. 5-5A for example purposes only) that may be included within the surrounding fairing covering the LVFS 20 or at least the payload module 22. As can be realized from FIGS. 5-5A, with the exception of cargo canisters 36, the payload module 22 of the LVFS 20 may be unpressurized. The structure of the payload module 22 of LVFS 20 is thus very simplified, and much lighter in comparison to the conventional payload module structure 322 of a conventional launch vehicle final stage 320 as illustrated schematically in FIG. 10. The payload module 22 of LVFS 20 also does not employ a heavy hatch for mating with the docking port on the orbiting spacecraft. This reduction in mass of the payload module structure in comparison to conventional payload modules provides a concomitant improvement in the payload mass capability of the LVFS 20 compared to conventional final stages as seen in FIG. 5, the LVFS 20 may also include a small compressed air tank 38, that may be located in the payload module 22 if desired, to provide pressurization air when the LVFS 20 is mated to the adapter 200 as will be later described.

Referring now to FIG. 6, there is shown a perspective view of the orbiting space tug 16 of the resupply system 10. The tug 16 is illustrated in FIG. 6 as a representative small spacecraft, and in alternate embodiments any suitable spacecraft may be used.

In this embodiment, the space tug 16 is shown in FIG. 6 as being similar to or a derivative of the Loral LS-400 spacecraft bus for example purposes. In general, the tug 16 has a bus 40 with a power system 42, a propulsion system 44, an altitude control system 46 and a command and guidance system 48. The bus 40 also includes docking or grappling clamps 50 for capturing and holding the LVFS during ferry maneuvers to the orbiting spacecraft 100. The power system 42 may include solar panels or any other means for generating power which is distributed by the power system to any of the other support (propulsion, altitude control, command and guidance) systems. The propulsion system 44 may include a thruster(s) with a desired propellant to perform the ferry maneuvers as will be described further below. The altitude control system 46 may include momentum wheels and/or thrusters to provide 3-axis stabilization of the space tug when mated to the LVFS. The command and guidance system includes communication electronics/antennas, suitable position/altitude sensors and processors to provide the space tug 16 with appropriate guidance and control capability and appropriate redundancy to rendezvous and dock with the LVFS 20, captive-carry the LVFS to the orbiting spacecraft 100 and deliver the LVFS 20 to the docking port of the orbiting spacecraft 100. Table 1 below, lists exemplary operating parameters for three spacecraft bus types that may be used as the space tug of the resupply system 10 (see FIG. 1).

TABLE I
Orbiting Spacecraft is at 450 km altitude.

| Description | Type 1 | Type 2 | Type 3 |
|---|---|---|---|
| | 1^{st} Generation | 2^{nd} Generation | Space-based |
| | Tugboat | Tugboat | Upper stage |
| Orbit altitude | 450 km | 200 km | 80 km |
| used for launch | | | |
| vehicle target | | | |
| Rapid call-up | Yes | LV must target | Yes |
| | | 450 km, | |
| | | otherwise 2-day | |
| | | delay | |
| Dry mass | 300 kg | 1000 kg | 1000 kg |
| Propellant | 80 kg | 2200 kg | 21000 kg |
| capacity | | | |
| Refueling | No | Yes | Yes |
| necessary | | | |
| Propellant | Monoprop. | Bi-propellant | Cryogenic |
| | Hydrazine | (NTO/MMH) | (LOX/LH2) |
| Specific Impulse | 220 s | 310 s | 440 s |
| Range of | 400-500 km | 200-500 km | 80-500 km |
| altitude | | | |
| Typical ΔV per | 20 m/s | 340 m/s | 4200 m/s |
| cargo retrieval | | | |
| mission | | | |
| Typical cargo | 1500 kg | 1660 kg | 11000 kg |
| mass | | | |
| Typical ferried | 2070 kg | 2230 kg | 11600 kg |
| mass | | | |
| Typical | 20 kg | 500 kg | 20000 kg |
| propellant mass | | | |
| per mission | | | |
| Number of | 4 (not | 4 per refueling | 1 per |
| missions | refueled) | | refueling |
| Spacecraft bus | L400 (Loral) | L1300 (Loral) | |
| Aerodynamic | No | No | Ballute |
| decelerator? | | | |
| Time for | 3 hours | 3 hours | 1 minute |
| rendezvous | | | |

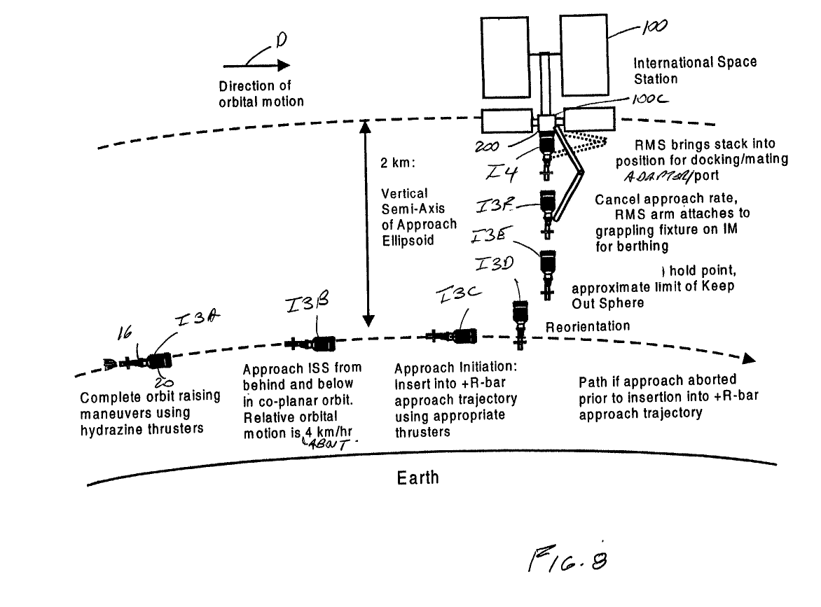

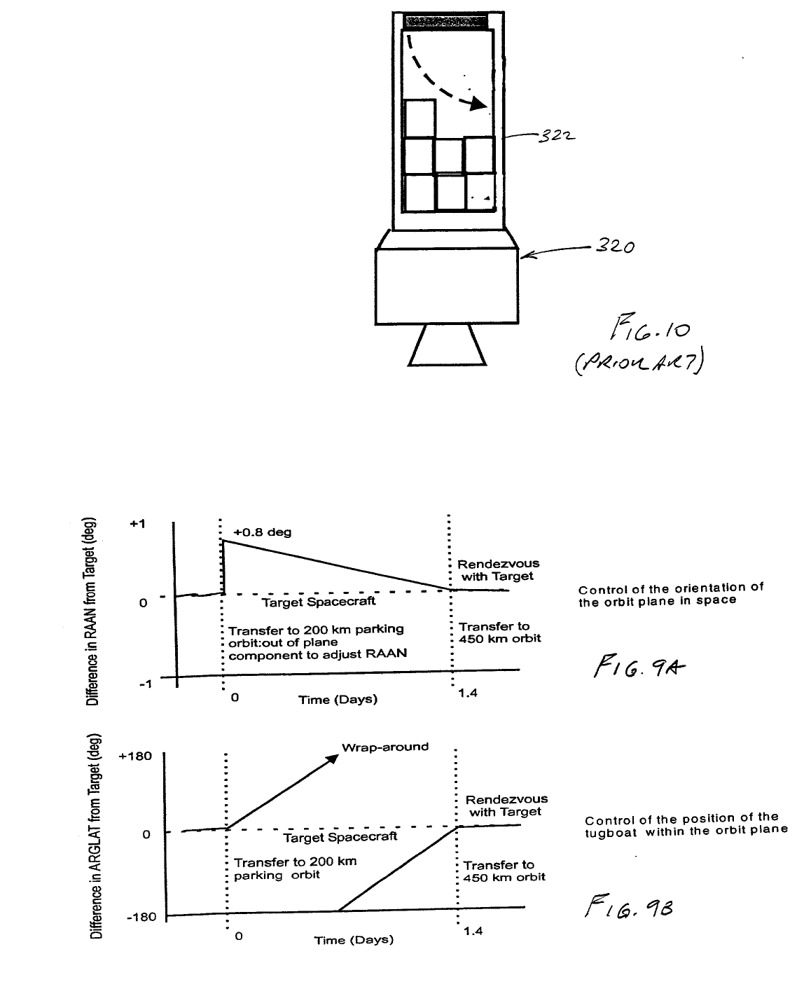

As can be realized from Table I, the Type 1 spacecraft bus provides a low cost space tug with modest maneuvering capability. In this case, the space tug 16 would not be refuelable and may be de-orbited after completing a number of missions (the number of missions shown in Table I, along with the other figures indicated in the table for all spacecraft types are merely exemplary and in alternate embodiments various parameters may be different as desired). The Type 2 and Type 3 spacecraft buses have a progressively larger maneuvering capability and may be refueled between missions as indicated in Table I. Accordingly, the Type 2 and Type 3 spacecraft represent more costly spacecraft buses for the space tug in comparison to the Type 1 spacecraft bus. A suitable means for refueling the Type 2 or Type 3 spacecraft bus is described in U.S. patent application Ser. No. 09/598,128, filed on Jun. 21, 2000 which is incorporated by reference herein in its entirety. FIG. 4 is a schematic side view that illustrates a launch and rendezvous profile used with the resupply system 10 in FIG. 1 in the case when the space tug 16 is substantially a Type 1 spacecraft bus. FIG. 9 is another schematic view that illustrates another launch and rendezvous profile of the resupply system in the case when the space tug was a Type 2 spacecraft bus. FIG. 11 is another schematic diagram illustrating still another launch and rendezvous profile of a resupply system 10′ having a space tug 16′ with a Type 3 spacecraft bus.

The resupply system 10 in FIG. 1, allows for a rapid call-up launch for resupplying the orbiting spacecraft 100 in orbit O. The system 10 allows payload delivery to occur as soon as possible after cargo liftoff. The total time from receiving a request for the payload to on-orbit delivery of the payload may be about one week or less. This would not be feasible with conventional launch systems. As noted before, FIG. 2 illustrates that in a given period (in this case a representative period of 26 hours) the ground track of spacecraft 100 in orbit O does not traverse a given ground site CAPE. There are however, a number of segments G1-G4 of the ground track that pass sufficiently close to the given site CPAE so as to be within the range of the mobile launcher 12 in the event the mobile launcher is based proximate site CAPE. Both northbound G1-G2, and southbound segments G3-G4 pass within the range of the mobile launcher 12. This in effect doubles the launch opportunities to resupply the spacecraft 100 using system 10 as will be seen further below. Referring now to FIG. 3, there is shown a schematic top view illustrating a representative ground track segment GO of the spacecraft 100 and the trajectory path of the launch vehicle 14 to boost the LVFS 20 into orbit. The ground track segment G0 is shown for example purposes only as being a northbound segment. As noted before, the system 10 is capable of launching the LVFS 20 for rendezvous with the orbiting spacecraft 100 when the spacecraft has a southbound ground track segment as will be evident below. As shown in FIG. 3, the mobile launcher 12 of system 10, carrying the launch vehicle 14 travels (from a given basing site which may be anywhere within the range of the mobile launcher from the given ground track segment G0). Along the path indicated by arrow FP to a designated launch point LP. The launch point LP intersects the ground track segment GO of the spacecraft 100 (i.e. is in the orbit plane of the spacecraft 100). As can be realized, the launch point LP is established to define an angular offset (not shown) from the orbiting spacecraft 100 of appropriate angle at the time of main engine start of the launch vehicle 14. As the mobile launcher 12 reaches the launch point LP at the appropriate time, the launch vehicle is deployed from the mobile launcher and disposed in the proper orientation for launch. The launch azimuth of the launch vehicle is not restricted. This allows the launch vehicle 14 to launch the payload in the orbit plane of the orbiting spacecraft. The ascent trajectory indicated by arrow A7 in FIG. 3) follows (i.e. is coplanar with) the ground track G0 of the orbiting spacecraft 11. The unrestricted launch azimuth of the launch vehicle 14 allows the launch vehicle to along the northbound track G0 or along a southbound track.

FIG. 4 shows a side view of the launch and rendezvous of which only a portion is shown in the top view of FIG. 3. At the time of main engine start of the launch vehicle 14 (at position LP in FIG. 3) the space tug 16 is at position R1 along the orbit path O. In this case, the orbit of space tug 16 when in position R1 is in substantially the same plane, and has substantially the same parameters (e.g. inclination i, RAAN, inclination, eccentricity, altitude) as the orbit O of spacecraft 100 to be resupplied. In addition, the angular offset between the spacecraft 100 and the space tug 16 when the space tug is at position R1 is such as to allow performance of the ferrying mission as will be noted below. As shown in FIGS. 3 and 4, the launch vehicle boosts the LVFS 20 to a position I1 where the engine 32T of the LVFS fires to inject the LVFS into orbit. The LVFS achieves orbit in position 22 as shown in FIGS. 3 and 4. The LVFS 20 at this point has an orbit which is also in the same orbit plane as both spacecraft 100 and space tug 16, and has the same orbit parameters as orbit O of the spacecraft 100 and space tug. FIGS. 1 and 4 show in this case that the LVFS 20 is offset back (i.e. opposite the direction of orbit indicated by arrow D) from the spacecraft 100, but ahead (i.e. in the direction of orbit) of the space tug 16. In alternate embodiments, the positional order between the spacecraft, LVFS, and tug may be reversed if desired with the tug forward most in the orbit direction, then the LVFS, and the spacecraft last. The order shown in FIGS. 1 and 4 may facilitate rendezvous with the spacecraft 100 from below which may be desirable in the case of the ISS. As noted before, after achieving orbit, the LVFS 20 has substantially no maneuvering capability. The tug 16 propulsion system 44 (see FIG. 6) is thus used to rendezvous and dock with the LVFS 20. This is schematically illustrated at position I3 in FIGS. 1 and 4. In order to rendezvous with the LVFS 20 in the case, the tug 16 may generate a velocity increment of about 5 m/s. The tug 16 captures and docks to the LVFS 20 using capture system 50.

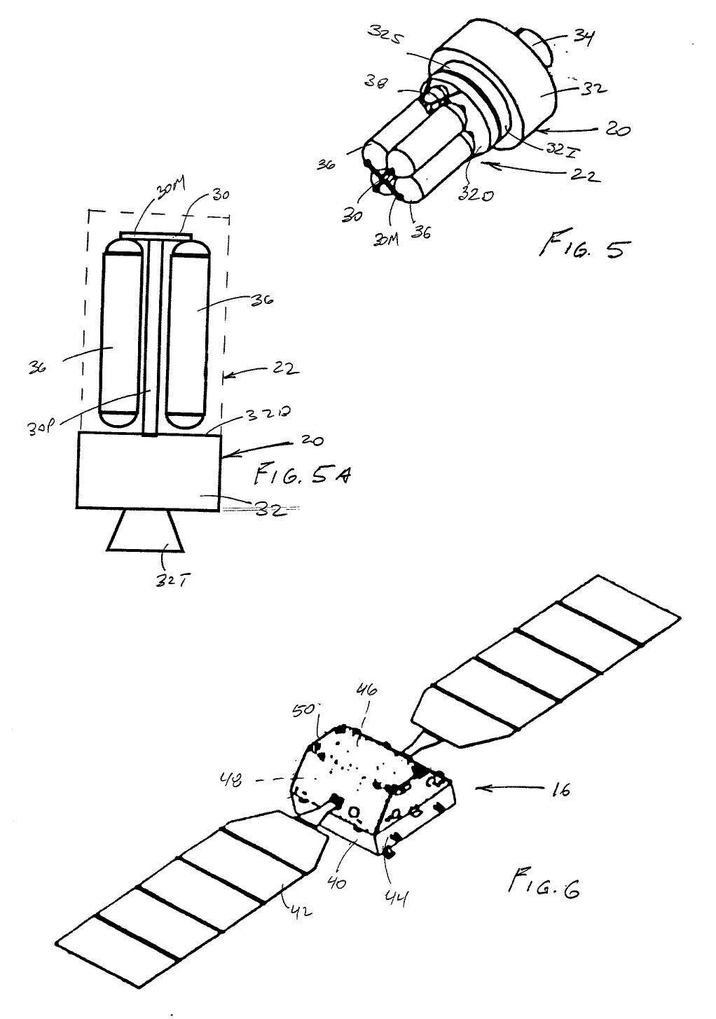

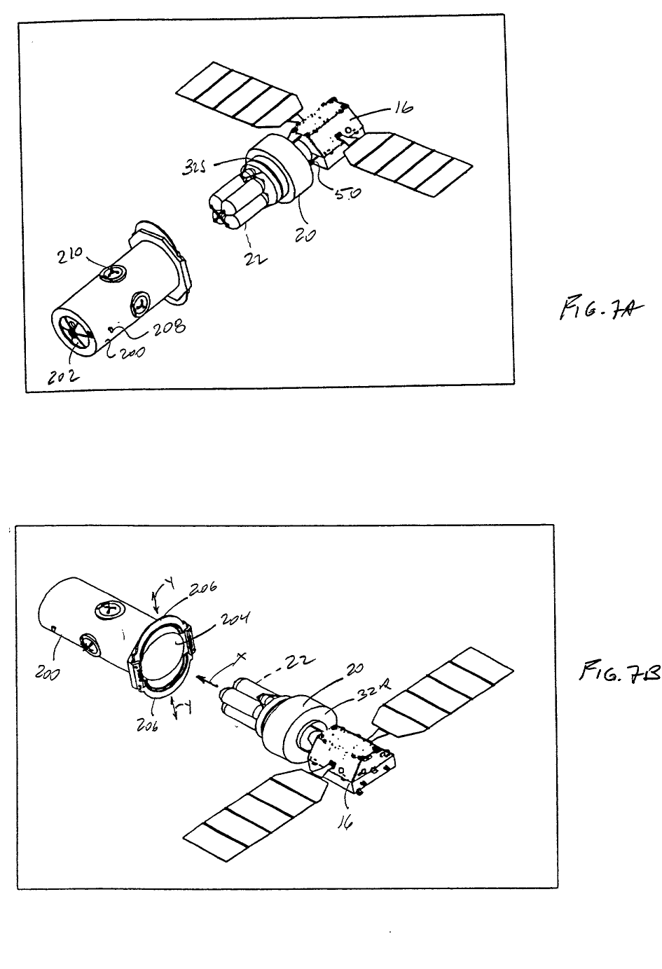

Referring now to FIGS. 7A-7B, there is shown respectively to opposing perspective views of the LVFS and tug stack 16, 20. In this embodiment, the tug 16 captures the LVFS from the rear end 32R of the LVFS. Accordingly, the stack 16, 20 has the tug positioned at one end, and the payload module 22 of the LVFS located at the other end of the stack. In alternate embodiments, the tug may hold the LVFS in any other suitable arrangement (e.g. such as a piggyback arrangement). The propulsion system 44 of the tug 16 is then used to reposition the LVFS tug stack 16, 20 and dock the payload module 22 to the orbiting spacecraft (indicated respectively at positions I3A and I4 in FIGS. 1 and 4). The tug propulsion system may generate a velocity increment of about 10 mk to reposition the stack and rendezvous with spacecraft 100 in the case. FIG. 8 shows a schematic side vie of the LVFS/tug stack 16, 20 in a number of positions I3A-I4 as the stack approaches and docks with orbiting spacecraft. In FIG. 8, the orbiting spacecraft is depicted as the I3C which has its docking port 100C facing the earth. In positions I3B and I3C the stack 16, 20 approaches the spacecraft from behind and below. Relative motion may be about 4 km/hr. At position I3D the tug 16 orients the stack to be aligned generally with the docking port 100C of the spacecraft. The tug 16 then moves the stack in for docking (positions I3D, 83E). In this case, spacecraft 100 is provided with a remote manipulating system (RMS) which may be used as shown in FIG. 8 to capture the stack and assist in docking the payload module to the docking port 100C (positions I3F, I4). In alternate embodiments, the tug 16 may maneuver the stack directly into contact with the spacecraft for docking.

The payload module 22 of the LVFS 20 in this case is docked to the docking port 100C of this spacecraft using unpressurized payload docking adapter 200. FIGS. 7A-7B show opposing perspective views of the adapter 200. As seen in FIGS. 7A-7B, the adapter 200 has a substantially cylindrical body with a hatched port 202 at one end and an LVFS interface port 204 at the other end. The LVFS port 204 may be configured to be open when not mated to the LVFS. Thus, the adapter 200 is unpressurized when not being used. The hatched port 202 is configured to be sealably coupled to the resupply port 100C of the spacecraft. This allows operators inside the spacecraft access to the hatch of the hatched port 202. The adapter 200 includes an appropriate vent 208 which is normally closed. The exterior of the adapter 200 may have a number of grappling fixtures allowing the RMS to grab and maneuver the adapter 200 for coupling with the port 100C. In this embodiment, the adapter may be stowed at a suitable location on the spacecraft and then berthed to the port 100C prior to a payload delivery mission. The LVFS interface port 204 may have movable doors 206 (two doors are shown, but any number of doors may be used). The doors 206 may be moved in the direction indicated by arrows Y between disengaged and engaged positions. In the disengaged position, the doors 206 are moved sufficiently apart to allow the payload module 72 (i.e. the canisters and support structure) of the LVFS 20 to enter into the adapter 200 in the direction indicated by arrow Y in FIG. 2B. In the engaged position, the doors 206 are positioned to be seated against surface 32S of the LVFS thereby forming an airtight seal. The air canister 38 (see FIG. 5) on the LVFS may then be used to pressurize the adapter 200. After being pressurized, the hatch in port 202 may be opened to access the payload canisters 36. The payload canisters 36 may be removed as noted before from the LVFS and brought through the adapter into the spacecraft for unloading the payload. The empty canisters may then be filled with any desirable materials for removal from the spacecraft 100.

FIG. 9 shows an alternate approach for launch and rendezvous with the orbiting spacecraft. This involves the tug performing an out of plane maneuver as depicted in the graphs shown in FIGS. 9A-9B. This consumes a larger amount propellant than the approach shown in FIG. 4, and would employ a tug having a Type 2 or Type 3 bus.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. An orbiting spacecraft payload delivery system for delivering a payload to an orbiting spacecraft, the system comprising:
a launch vehicle having a payload module for holding the payload for the orbiting spacecraft;
a mobile launcher adapted to transport the launch vehicle; and
an orbiting reusable space tug for ferrying the payload module to the orbiting spacecraft;
wherein the mobile launcher transports the launch vehicle to a predetermined location disposed within a predetermined distance from a ground track of the orbiting spacecraft for launching the launch vehicle from the predetermined location.

2. The system according to claim 1, wherein the predetermined distance is such that the predetermined location is on the ground track of the orbiting spacecraft.

3. The system according to claim 1, wherein the launch vehicle launched from the predetermined location places the payload module in the same orbit plane as the orbiting spacecraft.

4. The system according to claim 1, wherein the launch vehicle launched from the predetermined location places the payload module in a different orbit plane than an orbit plane of the orbiting spacecraft.

5. The system according to claim 4, wherein the different orbit plane has an inclination that is the same as the orbit plane of the orbiting spacecraft.

6. The system according to claim 1, wherein the space tug ferries the payload module from a first orbital position to a second orbital position, wherein the payload module is inserted into the first orbital position by the launch vehicle, and the orbiting spacecraft is located in the second orbital position.

7. The system according to claim 6, wherein the first and second orbital positions are disposed in one orbital plane.

8. The system according to claim 6, wherein the first and second orbital positions are located in different orbital planes.

9. The system according to claim 1, wherein the payload module is unpressurized.

10. The system according to claim 1, wherein the payload module has at least one pressurized container for holding the payload.

11. The system according to claim 1, further comprising an unpressurized payload docking adapter for interfacing the payload module to a docking port of the orbiting spacecraft.

12. The system according to claim 11, wherein the docking port is on a pressurized area of the orbiting spacecraft and the payload module is unpressurized, and wherein the adapter provides an interface between the docking port and the payload module allowing user access from the docking port into the payload module.

13. The system according to claim 11, wherein when connected to the payload module, the adapter forms a seal with part of the payload module so that the adapter is capable of being pressurized.

14. The system according to claim 11, wherein the adapter is launched into orbit at a different time than the payload module, and wherein the adapter is reusable to interface with a number of different payload modules.

15. The system according to claim 1, wherein the space tug is non-refuelable, and wherein the space tug is reusable for serially ferrying a number of different payload modules to the orbiting spacecraft.

16. An orbiting spacecraft payload delivery system for delivering a payload to an orbiting spacecraft in a predetermined orbit plane, the system comprising:
a launch vehicle having a payload module for holding the payload for the orbiting spacecraft;
a mobile launcher adapted to transport the launch vehicle; and
a reusable orbiting tug for ferrying the payload module to the orbiting spacecraft after the payload module is released from the launch vehicle;
wherein the mobile launcher transports the launch vehicle to a predetermined location for launching the launch vehicle from the predetermined location, the predetermined location being in the orbit plane of the orbiting spacecraft.

17. The system according to claim 16, wherein when being launched, the launch vehicle and spacecraft are separated by a predetermined argument of latitude so that when placed in orbit by the launch vehicle, the payload module is in proximity to the spacecraft.

18. The system according to claim 16, wherein the launch vehicle places the payload module in the same orbit as the spacecraft.

19. The system according to claim 16, wherein the mobile launcher is at least one of an airborne mobile launcher, a water borne mobile launcher, or a land borne mobile launcher.

20. The system according to claim 16, wherein the launch vehicle has an expendable portion that includes at least a final stage of the launch vehicle, and wherein the payload module is held by the final stage of the launch vehicle.

21. The system according to claim 16, further comprising an unpressurized payload docking adapter for interfacing the payload module to a docking port of the orbiting spacecraft, the adapter orbiting in proximity to the spacecraft.
